(19) United States
(12) Patent Application Publication
(10) Pub. No.: US 2015/0300328 A1
(43) Pub. Date: Oct. 22, 2015

(54) THERMOELECTRIC GENERATOR COMPRISING A DEFORMABLE BY-LAYER MEMBRANE EXHIBITING MAGNETIC PROPERTIES

(71) Applicant: STMICROELECTRONICS (CROLLES 2) SAS, Crolles (FR)

(72) Inventors: Onoriu Puscasu, Grenoble (FR); Stephane Monfray, Eybens (FR); Thomas Skotnicki, Crolles-Montfort (FR); Christophe Maitre, Barraux (FR)

(73) Assignee: STMICROELECTRONICS (CROLLES 2) SAS, Crolles (FR)

(21) Appl. No.: 14/686,299

(22) Filed: Apr. 14, 2015

(30) Foreign Application Priority Data
Apr. 17, 2014 (FR) 1453463

(51) Int. Cl. F03G 7/06; H02N 1/08

(52) U.S. Cl. CPC F03G 7/06; H02N 1/08

(57) ABSTRACT

An electrical generator is composed of a bi-layer membrane enabling the conversion of a thermal energy into electrical energy. The bi-layer membrane is deformable and includes at least two layers having different thermal expansion coefficients. The membrane moves between positions in a reversible fashion in response to heat dissipation and as a function of two flexing temperatures. A magnetic structure associated with the membrane functions to set the flexing temperatures as a function of ambient temperature.

### PRIORITY CLAIM

This application claims priority from French Application for Patent No. 1453463 filed Apr. 17, 2014, the disclosure of which is incorporated by reference.

### FIELD OF THE INVENTION

The invention relates to the technical field of thermo-electricity which consists in producing electricity from a heat source.

More particularly, the present application relates to a generator composed of a bi-layer membrane capable of converting thermal energy produced by a heat source into electrical energy via an intermediate conversion into mechanical energy. The term “bi-layer membrane” is understood to mean an assembly of at least two membranes which have different thermal expansion coefficients, arranged in such a manner as to deform the bi-layer membrane when its temperature varies.

### BACKGROUND

Heat is one of the richest sources of energy to be exploited. Hot objects produce a thermal power which is lost in the majority of cases. Examples of this are the heat produced by the engines of vehicles, industrial installations or the heat of the human body. The heat evacuated into the environment may be used as a free source of energy which, after conversion, could power electrical devices in order to render them autonomous. It is thus possible to replace or to complete the batteries of accumulators onboard these devices, a fact which can enable any maintenance needs to be limited.

Amongst the devices that have a need for an enhanced autonomy include wireless access points. When their primary function is the monitoring of the environment, these devices must be able to be deployed in large numbers at locations which are not connected to an electrical mains and it would be very advantageous to power them by recovering the energy coming from the outside environment. This is one of the applications that may be envisaged in the framework of the disclosed embodiments, which is aimed at the conversion of thermal energy into electrical energy.

In reality, the thermal energy is first of all converted into mechanical energy by means of a bi-layer membrane positioned in a region with a temperature gradient, then this mechanical energy, in the form of a movement, is converted into electrical energy. In order to be able to work, the bi-layer membrane is generally placed between a hot source and a cold source. These hot and/or cold sources may be solid material surfaces or volumes of hot or cold air, for example.

French Patent No. 2,990,301 (incorporated by reference) discloses one example of a generator composed of two electrodes facing each other, one of them being the bi-layer membrane. The heat emitted by a hot source heats the bi-layer membrane until it reaches a threshold temperature, also referred to as blistering temperature, at which it abruptly changes position in such a manner as to move away from the hot source and to come closer to a cold source. Since the quantity of heat from the hot source reaching the bi-layer membrane is then reduced, its temperature can progressively decrease until it falls below its threshold temperature (to within a certain hysteresis), also referred to as de-blistering temperature, so as to again deform and return to its original position. Thus, under the effect of a temperature gradient between the hot source and the cold source, the bi-layer membrane oscillates between two extreme positions. These cyclic deformations make the distance between the electrodes vary and, accordingly, the value of the capacitance formed by the said electrodes. Variations in voltage are accordingly generated across the terminals of the capacitance which are subsequently transmitted to a suitable circuit allowing an electrical device to be directly powered or else an accumulator supplying the said device to be charged. The quantity of electrical energy produced by the generator is an increasing function of the frequency of oscillation of the bi-layer membrane.

In the framework of the most common applications, such a device is placed on a hot surface and is cooled by the ambient air. For the cooling to be efficient, a cold member, such as a plate for example, can be placed between the bi-layer membrane and the ambient air. The bi-layer membrane thus touches a solid cold surface after flexing.

The range of operation of such a generator depends, on the one hand, on the blistering temperature of the bi-layer membrane. Indeed, the hot source temperature must be slightly higher than the latter so that the bi-layer membrane can be heated sufficiently to flex. On the other hand, the cold surface must be at a temperature lower than the temperature of de-blistering of the bi-layer membrane, so that the latter can be cooled sufficiently to return to its initial position. Given that the cold surface is situated between the hot source and the ambient air, its temperature will depend on the temperatures of these two. As a consequence, the higher the temperature of the hot source, the higher will be that of the cold surface. In other words, the two temperatures will vary together and, beyond a certain temperature of the hot source, the temperature of the cold surface will no longer be sufficiently low to cool the bi-layer membrane and to make it return to its initial position. Consequently, the generator will operate within a defined interval of temperatures of the hot source. It is usually situated at plus or minus 5° C. with respect to an optimum temperature of operation, which in turn is slightly higher than the blistering temperature of the bi-layer membrane.

If the temperature of the hot source is below this interval, the bi-layer membrane remains stationary in the non-blistered position. If the hot source temperature is above this interval, the bi-layer membrane cannot be sufficiently cooled and remains stationary in the blistered position. The electrical power produced by the generator in both cases is zero.

Given that, in the framework of the most common applications, the hot source temperature can vary within intervals of several tens of degrees (motors, industrial installations, hot water pipes), it is necessary to widen the range of operation of devices using a bi-layer membrane. This will ensure a better response to the cases of its use.

In order to overcome the drawback described hereinabove, one alternative consists in multiplying the number of generators comprising bi-layer membranes whose temperature thresholds are different in order to cover a wider range of operation. This technical solution is not ideal, because it is, on the one hand, costly owing to the number of generators needed to cover a relatively wide range of temperature and, on the other hand, it requires a hot source of large enough size to have an effect on all of the generators, which is not necessarily the case in practice.

### SUMMARY OF THE INVENTION

The applicant wishes to address the need identified hereinabove and, more particularly, provide an electrical generator composed of a bi-layer membrane whose range of temperatures of use can be adapted according to the temperature of the hot source powering it.

For this purpose, an electrical generator is provided comprising a bi-layer membrane enabling the conversion of a thermal energy into electrical energy, comprising: a deformable membrane comprising at least two layers whose thermal expansion coefficients are different, the said membrane being deformed in a reversible fashion between a first position situated near to a hot source and a second position situated near to a cold source when its temperature reaches a first flexing temperature or a second flexing temperature; means for converting the deformation of the said membrane into electrical energy; a first magnetic means rigidly fixed to the deformable membrane; a second magnetic means interacting magnetically with the first magnetic means, so as to modify the value of the first and second flexing temperatures of the deformable membrane.

According to several variants:

the first and the second magnetic means can establish an attractive or repulsive force, the first magnetic means can be formed by one layer of the bi-layer membrane,

the second magnetic means can be present between the deformable membrane and the hot source, the second magnetic means can be present between the deformable membrane and the cold source,

the first and/or the second magnetic means can be permanently magnetized,

the first and/or the second magnetic means can be non-magnetized,

the values of the magnetizations and/or of the magnetic susceptibilities of the first and/or of the second magnetic means can be substantially constant when their temperature varies,

the values of the magnetic susceptibilities of the first and/or of the second magnetic means can decrease when their temperature increases,

the values of the magnetic susceptibilities of the first and/or of the second magnetic means can increase when their temperature increases,

the value of the magnetic susceptibility and/or the magnetization of the first magnetic means can decrease when its temperature rises, and the value of the magnetic susceptibility and/or the magnetization of the second magnetic means can be substantially constant when its temperature varies,

the value of the magnetic susceptibility and/or the magnetization of the first magnetic means can increase when its temperature rises, and the value of the magnetic susceptibility and/or the magnetization of the second magnetic means can be substantially constant when its temperature varies,

the value of the magnetic susceptibility and/or the magnetization of the first magnetic means can be substantially constant when its temperature rises, and the value of the magnetic susceptibility and/or the magnetization of the second magnetic means can decrease when its temperature rises,

the value of the magnetic susceptibility and/or the magnetization of the first magnetic means can be substantially constant when its temperature rises, and the value of the magnetic susceptibility and/or the magnetization of the second magnetic means can increase when its temperature rises.

An electronic component is also provided incorporating a generator such as provided hereinabove.

### BRIEF DESCRIPTION OF THE FIGURES

Certain aspects of the invention will be better understood upon reading the description that follows, given solely by way of example, and presented in relation with the appended drawings, in which the same references denote identical or analogous elements and in which:

FIG. 1 is a simplified summary perspective view of a first embodiment of a generator operating on a capacitive principle comprising a bi-layer membrane shown in a first position;

FIG. 2 is a simplified view in longitudinal cross section of the generator according to FIG. 1, in which the bi-layer membrane is shown in a first position;

FIG. 3 is a view analogous to FIG. 2, in which the bi-layer membrane is shown in a second position;

FIGS. 4 to 8 are graphs respectively showing curves I to V, illustrating the flexing of the bi-layer membrane of the generator according to FIGS. 1 to 3, between its first and its second position as a function of the variation of its temperature, and according to various configurations of position of the magnetic layers and their properties;

FIG. 9 is a simplified view in longitudinal cross section of a second embodiment of a generator operating on a capacitive principle, comprising a deformable bi-layer membrane shown in a first position;

FIG. 10 is a view analogous to FIG. 9, in which the deformable electrode is shown in a second position;

FIG. 11 is a simplified summary perspective view of a third embodiment of a generator operating on a piezoelectric principle comprising a bi-layer membrane shown in a first position;

FIG. 12 is a simplified view in longitudinal cross section of the generator according to FIG. 11, in which the bi-layer membrane is shown in a first position;

FIG. 13 is a view analogous to FIG. 12, in which the bi-layer membrane is shown in a second position;

FIG. 14 is a simplified view in longitudinal cross section of a fourth embodiment of a generator operating on a piezoelectric principle, comprising a bi-layer membrane shown in a first position; and

FIG. 15 is a view analogous to FIG. 14, in which the bi-layer membrane is shown in a second position.

### DETAILED DESCRIPTION OF THE FIGURES

In order to generate electricity from a hot source, various embodiments are provided of a generator composed of a thermal bi-layer membrane one of the features of which is the ability to adapt its range of operation according to the temperature of the hot source. The term “ranges of operation” is understood to mean a range of temperatures within which the generator produces electricity.

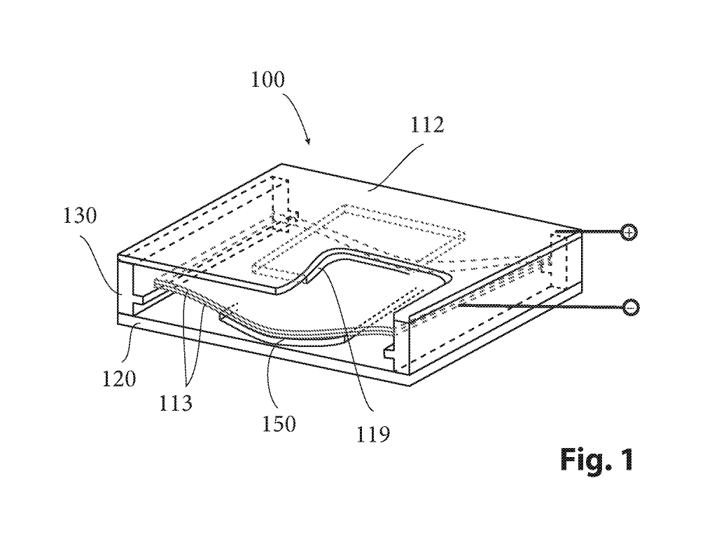

According to a first exemplary embodiment, the generator 100 illustrated in FIGS. 1, 2 and 3 comprises a capacitor 110 with variable capacitance resting on a support 120, in contact with a hot source 1. By way of example, the hot source can be a hot water pipe, whose temperature can vary between 40° C. and 90° C. or more. It may also be an electrical installation, whose temperature can vary between 60° C. and 150° C.

More precisely, the variable capacitor 110 is formed by the metal plate 112, which plays the role of fixed electrode, and the bi-layer membrane 111, which plays a role of counter-electrode or of mobile electrode. In the case where the bi-layer membrane is made of metal, as illustrated in FIGS. 1 to 3, it is one of its layers, and advantageously its top layer, which has the highest thermal expansion coefficient. It is however possible to include an additional layer deposited onto the bi-layer membrane, which plays the role of electrode, without acting in the thermal expansion phenomena of the bi-layer membrane.

It should be noted that, in the case where the plate 112 is thermally conducting, and notably metal, it may also play the role of cold surface.

Advantageously, the capacitor may include an electret 119, which serves as source of permanent polarization. This then avoids having to use a pre-charged capacitor in parallel with the variable capacitor. This electret 119 is interposed between the two electrodes and, for example as illustrated in FIGS. 1 to 3, underneath the plate 112. The deformable electrode 111 is able to deform under the effect of a variation in its temperature, in such a manner as to move away or come closer to the fixed electrode 112. The movement of the bi-layer membrane 111 leads to a variation in the capacitance of the capacitor 110. The electrodes of the capacitor 110 are connected to an energy recovery circuit 140 which denotes any system enabling the conversion of the variations of the capacitance of the capacitor 110 into a usable form of electrical energy. By way of example, such systems are described in the document U.S. Pat. No. 7,781,943 (incorporated by reference).

The plate 112 is held facing, and at a constant distance from, the support 120 by means of a chassis 130 fabricated with a thermally insulating material. The plate 112 also plays the role of cold surface. The cold source 2 is characterized by a temperature which is lower than the temperature of the hot source 1. The cold source may for example denote the ambient environment.

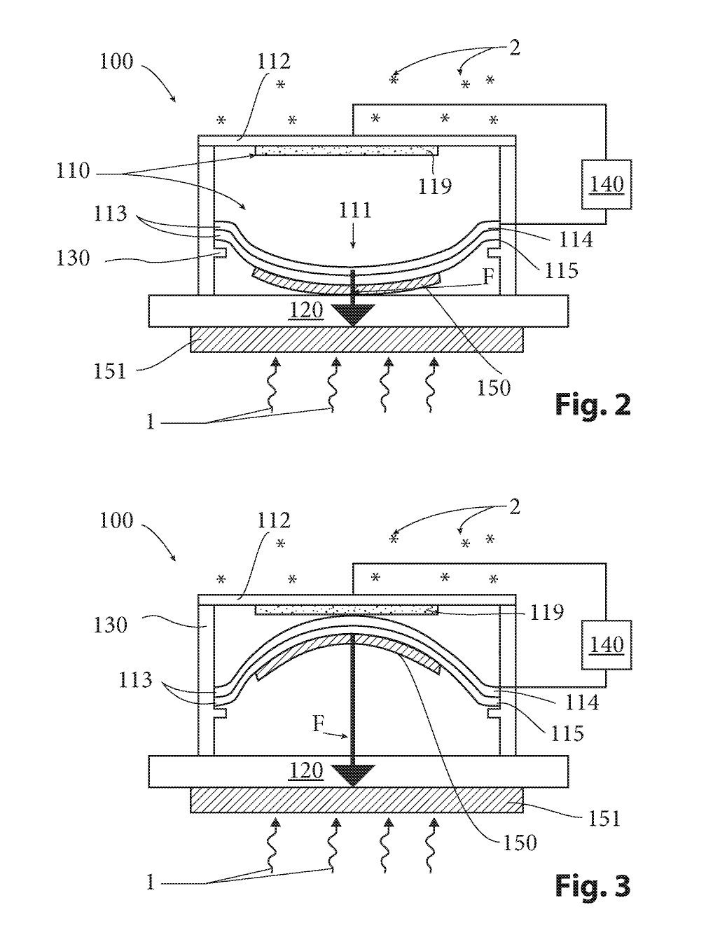

As illustrated in FIG. 3, the deformable electrode 111 comprises a thermal bi-layer membrane 113 formed from at least two layers 114 and 115 whose thermal expansion coefficients are different. In particular, one of the layers 114 and 115 of the bi-layer membrane 113 is made of a material that is a good electrical conductor in order to serve as an electrode. It is of course possible, as a variant, to add an additional electrically conducting layer to one of the layers 114 and 115 of the bi-layer membrane 113 in order for it to serve as an electrode.

The bi-layer membrane 113 is mechanically held between the lateral walls of the chassis 130 in such a manner as to allow the bi-layer membrane to be freely deformed and in a reversible fashion when its temperature varies. The bi-layer membrane 113 is heated by the hot source 1 when it is in a first position (A), shown in FIG. 2, and is cooled by the cold source 2 when it is in a second position (B), shown in FIG. 3.

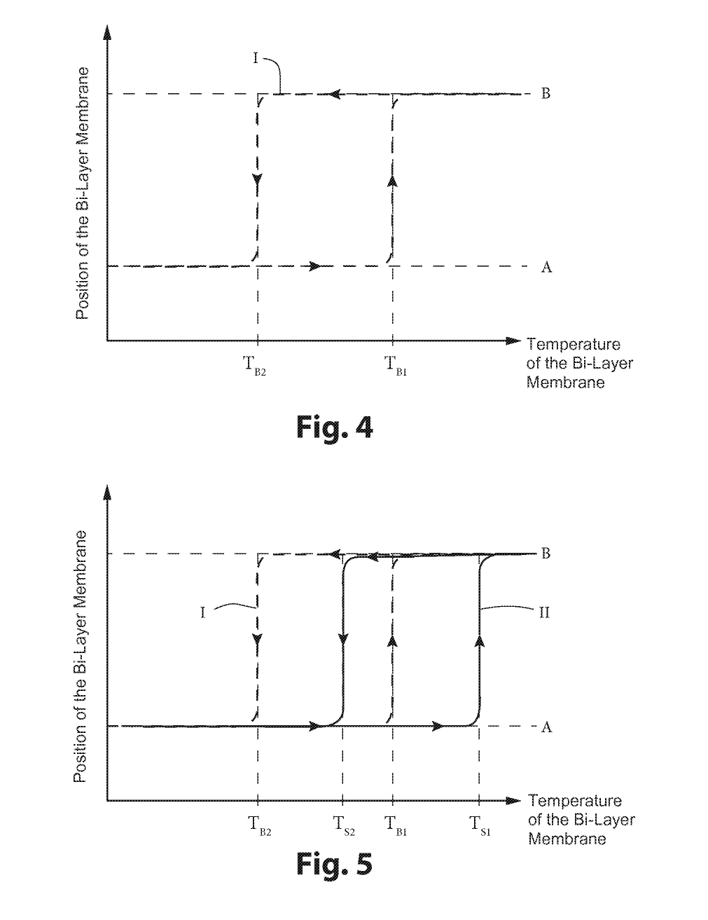

As illustrated by the curve I in FIG. 4, the bi-layer membrane 113 flexes from its first position (A) to its second position (B) when its temperature exceeds a first flexing temperature (TO. In order to return to its first position, the temperature of the bi-layer membrane must fall below a second flexing temperature (T_{B2}). Owing to the hysteresis of the bi-layer membrane 113, the first flexing temperature is higher than the second. As explained hereinabove, the conversion of thermal energy into electrical energy is obtained by virtue of the flexing of the bi-layer membrane in the capacitor 110 between the first and the second position. For this reason, the range of operation of the generator 100 depends on the value of the flexing temperatures and on the capacity of the hot source 1 to heat the bi-layer membrane 113 in its first position (A), combined with the capacity of the generator to cool the bi-layer membrane in its second position (B). For this purpose, the hot source 1 must have a temperature higher than the first flexing temperature (T_{B1}) of the bi-layer membrane and the cold source 2 must have a temperature lower than the second flexing temperature (T_{B2}) of the bi-layer membrane.

Owing to the reduced thickness of the generator 100, typically of the order of a few millimeters, the variation in the quantity of heat heating the deformable electrode 111 is relatively limited between its two positions. The cooling of the deformable electrode in its second position (B) is also limited owing to the cooling capacities of the cold source 2 which generally denotes the ambient air. For this reason, the temperature of the hot source 1 must not exceed a critical temperature beyond which the cold source 2 can no longer sufficiently cool the bi-layer membrane for it to be able to flex back into its first position (A). The situation is the same as regards the cold source, whose temperature must not be lower than a critical temperature below which the heat from the hot source is no longer sufficient to allow the bi-layer membrane to flex from its first (A) to its second (B) position. In practice, the range of operation of the generator is therefore limited to relatively narrow and precise ranges of temperatures, with an amplitude going from a few degrees to around 15° C., generally included between ambient temperature and 200° C., hence depending on the characteristic temperatures of the thermal bi-layer membrane.

Today, there accordingly exists a need for a generator composed of a thermal bi-layer membrane whose range of operation can be controlled so as to be able to adapt it according to its environment. In particular, it is desirable to be able to modify the range of operation and/or the position of its range of temperatures, in order to allow its use with more varied hot and cold sources.

In order to allow the shift in the range of operation of the generator 100 described here, and in order to adapt itself to the capacities of the hot source 1 and of the cold source 2, the bi-layer membrane 113 and the support 120 are respectively associated with magnetic layers 150 and 151 exhibiting magnetic properties, as illustrated in FIGS. 2 and 3. In the case where the variable capacitor is formed between the bi-layer membrane and the plate 112 associated with the cold source, the magnetized layer 150 is advantageously placed underneath the bi-layer membrane. This allows a high value of capacitance to be maintained when the bi-layer membrane is blistered, in other words in its second position, in contact with the electret 119. The magnetic layer 150 can thus play its role without interfering with the variable capacitor.

The magnetic layers 150 and 151 are chosen in such a manner as to establish attractive forces between the deformable electrode 111 and the support 120. At least one of the magnetic layers comprises a ferromagnetic or ferrimagnetic material so as to obtain a magnetization that persists over time. The term “attractive forces” is understood to mean magnetic forces that are established between two elements with magnetic properties, so as to cause then to come closer. These attractive forces are represented in FIGS. 2 and 3 by the arrows F.

The attractive forces F between the layers 150 and 151 are added to the mechanical stresses exerted between the layers 114 and 115 of the bi-layer membrane. These attractive forces are opposing the flexing of the bi-layer membrane from its first (A) to its second position (B). For this reason, as illustrated by the curve II in FIG. 5, it is necessary to heat the bi-layer membrane 111 up to a first threshold temperature (T_{S1}) which is higher than the first flexing temperature (T_{B1}) of the bi-layer membrane, in order to increase the stresses between the layers 114 and 115 of the bi-layer membrane and to allow its transition into its second position (B). In other words, the attractive forces established between the magnetic layer 150 and the magnetic layer 151 increase the first threshold temperature (T_{S1}) for flexing of the deformable electrode beyond the first flexing temperature (T_{B1}) of the bi-layer membrane 113.

In a complementary fashion, the attractive forces F between the magnetic layers 150 and 151 promote the flexing of the bi-layer membrane from its second position (B) to its first position (A). For this reason, the bending forces between the layers 114 and 115 of the bi-layer membrane do not need to be as high to allow its flexing. In other words, there is less need to cool the bi-layer membrane 113 in order to enable its flexing. For this reason, the second threshold temperature (T_{S2}) for flexing of the deformable electrode 111 between its second position (B) and its first position (A) is higher than the second flexing temperature (T_{B2}) of the bi-layer membrane, as illustrated by the curve II in FIG. 5.

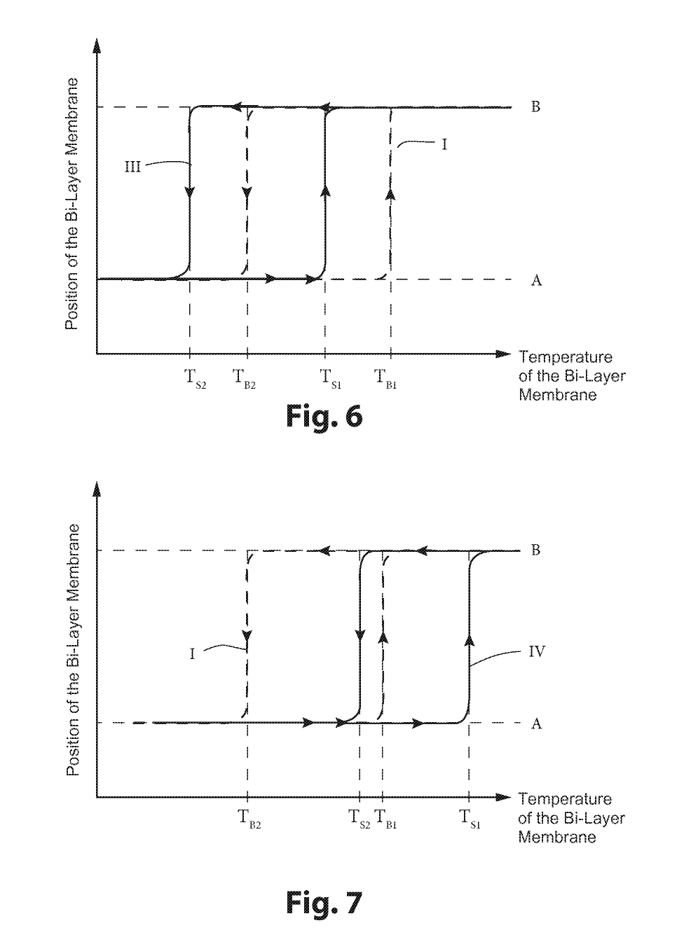

The attractive (or repulsive) forces F between the magnetic layers 150 and 151 therefore allow the range of operation of the generator 100 to be respectively shifted towards higher or lower temperature ranges. This shift can be controlled as a function of the intensity of the forces of attraction or of repulsion between the magnetic layers 150 and 151. Indeed, the greater the intensity of these forces, the larger is the respective shift between the temperatures (T_{S1}) and (T_{S2}) with respect to the temperatures (T_{B1}) and (T_{B2}). Such as illustrated by the curve III in FIG. 6, the opposite behavior may be obtained, with inverse shifts of the blistering and de-blistering temperatures, in other words their reduction, when the forces exerted between the magnetic layers 150 and 151 are repulsive, or else when the forces are attractive, but when one of the magnetic layers is situated on the side of the cold source.

In order to allow the range of operation of the generator 100 to be varied automatically, so as to be able to adapt it for example to a variation in the hot source temperature, at least one of the magnetic layers 150 and 151 is chosen such that its magnetic properties increase significantly when its temperature increases. This variation of the magnetic properties may correspond to an increase or to a decrease in the magnetization when the magnetic layer is a permanent element, exhibiting a permanent magnetization. This variation may correspond to a decrease in the magnetization with temperature that is observed with ferromagnetic materials, or certain ferromagnetic materials, within certain ranges of temperature. It may also correspond to an increase in the magnetization that is observed with certain ferromagnetic materials over a range of temperature. This variation of the magnetic properties with temperature may also be used to advantage for a material that does not have a permanent magnetization, by thus making the intensity of the forces vary with temperature which are exerted by reason of the magnetic field generated by a permanent magnet.

Materials should thus be used which have a magnetic susceptibility that varies with temperature, generally in the direction of a reduction, notably for some ferromagnetic materials.

For example, as illustrated by the curve IV in FIG. 7, when the forces established between the magnetic layers 150 and 151 are attractive, the deformable electrode 111 flexes from its first (A) to its second (B) position for a first flexing threshold temperature (T_{S1}) higher than the flexing temperature (T_{B1}) of the bi-layer membrane 113. The intensity of the attractive forces increases when the temperature of the magnetic layer 150 and/or 151 increases; for this reason, the attractive forces have a greater positive effect on the flexing of the bi-layer membrane between its second (B) and its first position (A). It is then not as necessary to cool the bi-layer membrane 113 in order to allow its flexing. The second threshold temperature (T_{S2}) is then higher than T_{S1}. In other words, owing to the increase in the intensity of the attractive forces between the magnetic layers 150 and 151, when their temperature increases, the range of operation of the generator can be extended. Amongst the materials whose magnetization can increase with the temperature are included certain ferrimagnetic materials such as NiO.Cr₂O₃, CoGd, GdFeCo.

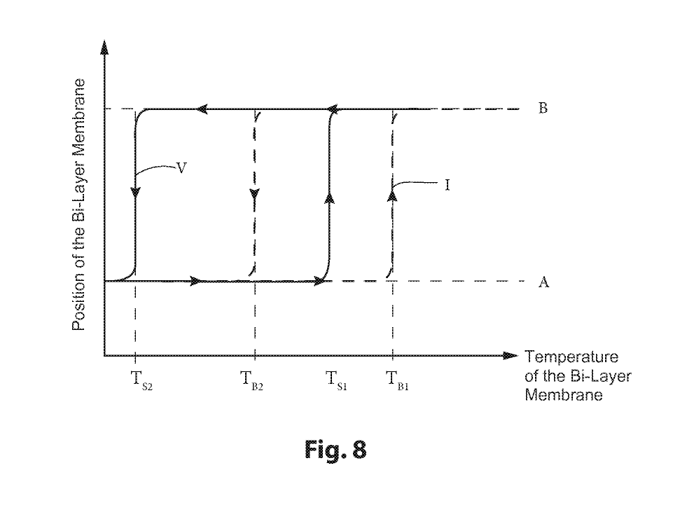

According to another example illustrated by the curve V in FIG. 8, when the forces established between the magnetic layers 150 and 151 are repulsive, the deformable electrode 111 flexes between its first (A) and its second (B) position for a first flexing threshold temperature (T_{S1}) which is lower than the flexing temperature (T_{B1}) of the bi-layer membrane 113. The intensity of the repulsive forces increases when the temperature of one and/or the other magnetic layer 150, 151 decreases. For this reason, the repulsive forces oppose to a greater extent the flexing of the deformable electrode 111 from its second (B) to its first position (A). It is then necessary to cool the bi-layer membrane 113 more in order to allow the flexing of the deformable electrode 111. The second flexing threshold temperature (T_{S2}) of the deformable electrode is therefore different from the second flexing temperature (T_{B2}) of the bi-layer membrane 113. In other words, owing to the increase in the intensity of the repulsive forces between the magnetic layers 150 and 151 when their temperature decreases, the range of operation of the generator can be widened. In order to obtain such a behavior, magnets of the Neodymium-Iron-Boron type or of the ferrite type may for example be used.

The range of operation of the generator 100 can therefore be automatically reduced or increased when, respectively, the intensity of the attractive or repulsive forces increases when the temperature of one and/or the other magnetic layer 150, 151 varies. In this way, the amplitude of the range of operation of the generator can be modified in a precise manner so as to be automatically adapted according to the characteristics of the hot source 1 and of the cold source 2.

By way of example, the magnetic layers 150 and 151 mentioned hereinabove may comprise at least one of the following materials: FeNi, NiMgGa, GdSiGe, NdFeB Fe₂O₃MnO, Fe₂O₃FeO, 6Fe₂O₃BaO, 6Fe₂O₃SrO.

According to one variant embodiment, the bi-layer membrane 113 and/or the support 120 may be formed from materials exhibiting magnetic properties so as to be able to implement the examples described hereinabove without the magnetic layer 150 and/or the magnetic layer 151.

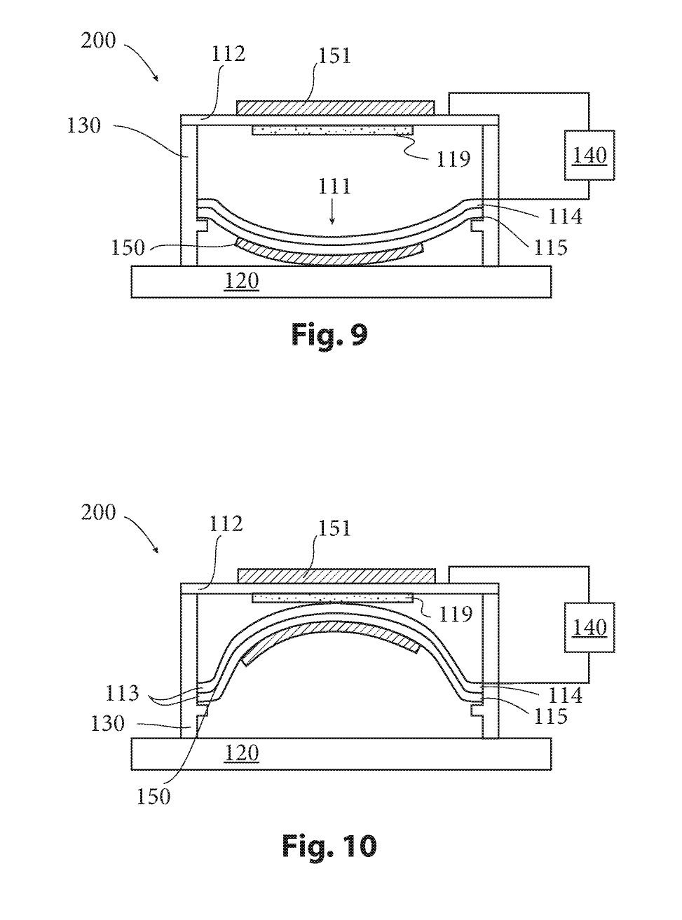

According to a second exemplary embodiment of a generator 200 illustrated in FIGS. 9 and 10, the layer 151 exhibiting magnetic properties is associated with the plate 112 near to the cold source, instead of the support 120 near to the hot source. This exemplary embodiment allows results identical to those described hereinabove to be obtained.

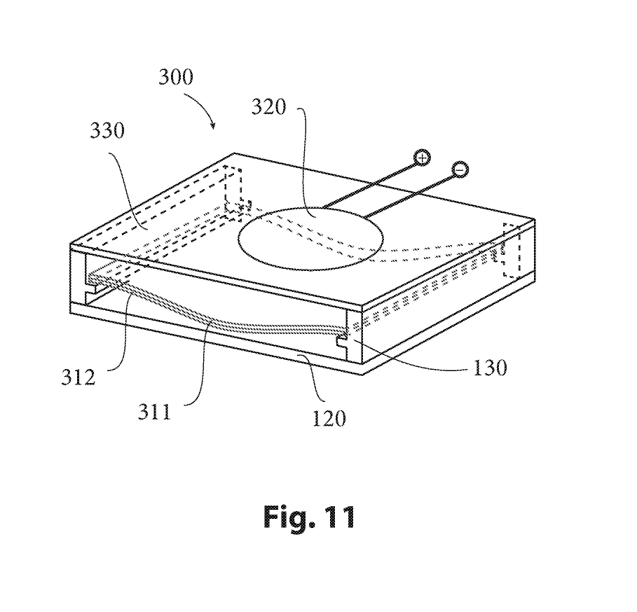

According to a third exemplary embodiment illustrated in FIGS. 11, 12 and 13, the generator 300 differs from the previous examples by the substitution of the capacitor 110 with a device comprising a deformable membrane 310 and a piezoelectric device 320 disposed on top of a membrane 330 rigidly attached to the lateral walls of the chassis 130 and facing the support 120.

The piezoelectric device 320 is connected to an energy recovery circuit 340 which denotes any system enabling the conversion of the electrical signals generated by this device into a usable form of electrical energy, such as for example mentioned hereinabove.

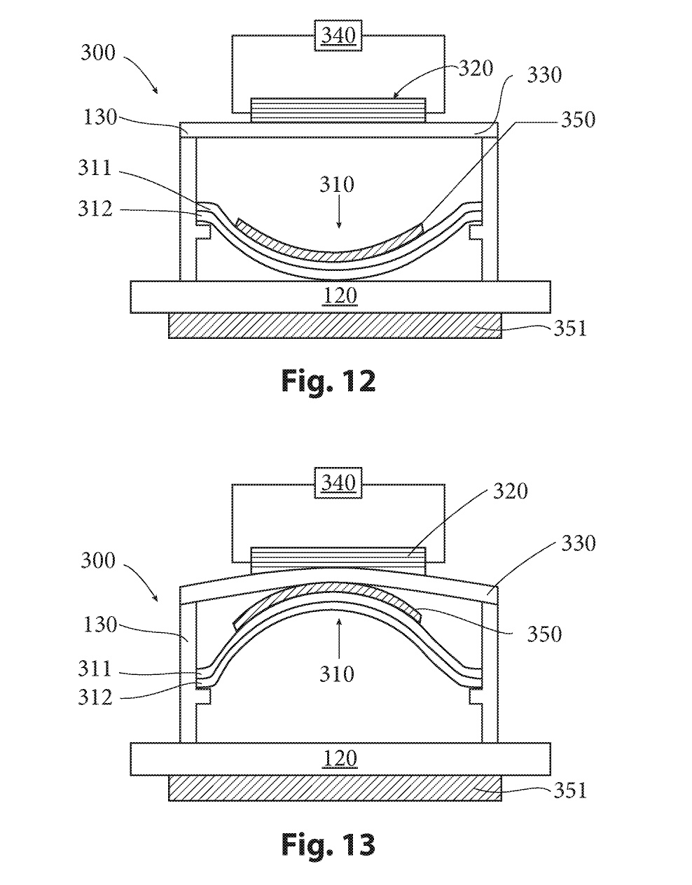

As illustrated in FIG. 12, the deformable membrane 310 comprises at least two layers 311 and 312 whose thermal expansion coefficients are different. The deformable membrane is placed under tension against the lateral walls of the chassis in such a manner as to be in contact with the support 120 in a first position (A) (see FIG. 12) and to exert a mechanical strain on the piezoelectric device 320 in a second position (B) (see FIG. 13). Thus, each time that the deformable membrane 310 is displaced from its first to its second position, the piezoelectric device is subjected to a strain and emits electrical signals which are converted into electrical energy by the energy recovery circuit 340.

In a similar manner to hereinabove, the flexing temperature of the deformable membrane may be modified by associating a magnetic layer 350 with the deformable membrane and by disposing the other magnetic layer near to either the hot source or to the cold source.

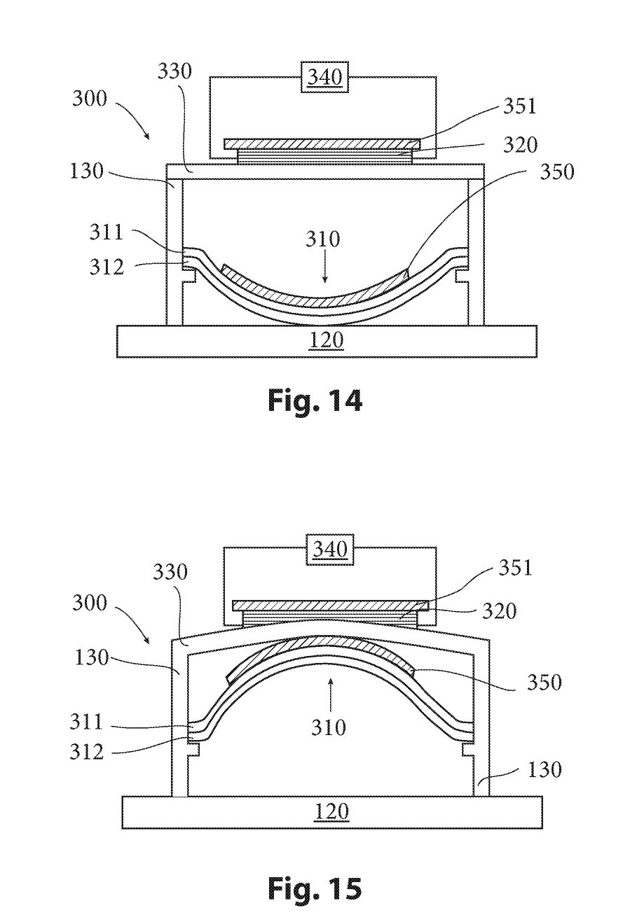

Thus, this layer 351 can be associated with the support 120 of the generator 300 as illustrated in FIGS. 12 and 13. The magnetic layer 351 can, on the contrary, be close to the cold source, and for example disposed on top of the piezoelectric device 320 such as illustrated in FIGS. 14 and 15.

The choice of the materials composing the magnetic layers 350 and 351 may be made in the same way as mentioned hereinabove, in such a manner as to adapt the range of operation of the generator 300 according to the capacities of the hot source 1 and of the cold source 2 to make the deformable membrane flex.

According to one variant embodiment, the deformable membrane 310 and/or the support 120 may be formed from materials exhibiting magnetic properties in such a manner as to be able to implement the examples described hereinabove without the magnetic layer 350 and/or the magnetic layer 351.

It goes without saying that the description hereinabove has only been presented for certain configurations, however many combinations are possible including:
the positioning of the magnetic means having a permanent magnetization on the bi-layer membrane, or close to the hot or cold sources;
the increasing or decreasing variation with temperature of the magnetization of the magnetic means with a permanent magnetization;
the increasing or decreasing variation with temperature of the magnetic susceptibility of the magnetic means with a non-permanent magnetization;
the position of the magnetic means (with a magnetization that is permanent or otherwise) interacting with the means with a permanent magnetization.

According to one alternative, several generators such as previously described may be associated with the same hot source in such a manner as to produce a greater quantity of electricity and/or to allow an even wider range of operation to be covered.

In conclusion, the generators described hereinabove allow their range of operation to be more precisely and automatically adapted according to their environment. Indeed, the range of operation of a generator composed of a bi-layer membrane according to the present invention can be adapted as a function of the dynamic behavior of the hot source and of the cold source designed to be in contact with the generator.

1. An electrical generator, comprising:
a bi-layer membrane configured to enable conversion of a thermal energy into an electrical energy, said bi-layer membrane comprising a deformable membrane comprising at least two layers whose thermal expansion coefficients are different,
wherein the membrane is deformable in a reversible fashion between a first position situated near to a hot source and a second position situated near to a cold source when temperature of the membrane reaches a first flexing temperature and a second flexing temperature, respectively;
a conversion circuit configured to convert the deformation of the membrane into electrical energy;
a first magnetic structure rigidly fixed to the deformable membrane;
a second magnetic structure interacting magnetically with the first magnetic structure so as to increase a value of the first and second flexing temperatures of the membrane in response to increase in temperature of the hot source.

2. The generator according to claim 1, wherein the first and the second magnetic structures establish an attractive force.

3. The generator according to claim 1, wherein the first and the second magnetic structures establish a repulsive force.

4. The generator according to claim 1, wherein the first magnetic structure is formed by one layer of the membrane.

5. The generator according to claim 4, wherein the second magnetic structure is present between the membrane and the hot source.

6. The generator according to claim 4, wherein the second magnetic structure is present between the membrane and the cold source.

7. The generator according to claim 4, wherein one of the first and second magnetic structures is permanently magnetized.

8. The generator according to claim 4, wherein one of the first and second magnetic structures is non-magnetized.

9. The generator according to claim 1, wherein a value of one of a magnetization and magnetic susceptibility of one of the first and second magnetic structures is substantially constant with increase in temperature.

10. The generator according to claim 1, wherein a value of a magnetic susceptibility of one of the first and second magnetic structures decreases with increase in temperature.

11. The generator according to claim 1, wherein a values of a magnetic susceptibility of one of the first and second magnetic structures increases with increase in temperature.

12. The generator according to claim 1, wherein a value of one of a magnetic susceptibility and magnetization of the first magnetic structure decreases with increase in temperature, and wherein a value of one of the magnetic susceptibility and magnetization of the second magnetic means is substantially constant with variation in temperature.

13. The generator according to claim 1, wherein a value of one of a magnetic susceptibility and magnetization of the first magnetic structure increases with increase in temperature, and wherein the value of one of the magnetic susceptibility and magnetization of the second magnetic structures is substantially constant with variation in temperature.

14. The generator according to claim 1, wherein a value of one of a magnetic susceptibility and magnetization of the first magnetic structure is substantially constant with increase in temperature, and wherein the value of one of the magnetic susceptibility and magnetization of the second magnetic structure decreases with increase in temperature.

15. The generator according to claim 1, wherein a value of one of a magnetic susceptibility and magnetization of the first magnetic structure is substantially constant with increase in temperature, and wherein the value of one of the magnetic susceptibility and magnetization of the second magnetic structure increases with increase in temperature.

16. An electronic component integrating a generator, wherein the generator comprises:
a bi-layer membrane configured to enable conversion of a thermal energy into an electrical energy, said bi-layer membrane comprising a deformable membrane comprising at least two layers whose thermal expansion coefficients are different,
wherein the membrane is deformable in a reversible fashion between a first position situated near to a hot source and a second position situated near to a cold source when temperature of the membrane reaches a first flexing temperature and a second flexing temperature, respectively;
a conversion circuit configured to convert the deformation of the membrane into electrical energy;
a first magnetic structure rigidly fixed to the deformable membrane;
a second magnetic structure interacting magnetically with the first magnetic structure so as to increase a value of the first and second flexing temperatures of the membrane in response to increase in temperature of the hot source.

17. An apparatus, comprising:
a bi-layer membrane including two layers whose thermal expansion coefficients are different, said membrane movable between positions in response dissipating heat from a heat source;
a capacitor having a first plate mounted to said bi-layer membrane and a second plate in a fixed position;
a circuit coupled to said capacitor and configured to convert changes in capacitance responsive to movement of the moveable membrane to electrical energy; and
a magnetic structure variably acting on said bi-layer membrane as a function of temperature to change temperature points associated with movement of the bi-layer membrane between said positions in response to increase in temperature of the heat source.

18. The apparatus of claim 17, wherein said magnetic structure comprises:
a first magnetic structure rigidly fixed to the membrane; and
a second magnetic structure interacting magnetically with the first magnetic structure so as to modify a value of first and second temperatures at which the membrane flexes between positions.

19. The apparatus of claim 18, wherein one of the first and second magnetic structures is permanently magnetized.

20. The apparatus of claim 18, wherein one of the first and second magnetic structures is non-magnetized.
